(19) United States
(12) Patent Application Publication
(10) Pub. No.: US 2026/0163815 A1
(43) Pub. Date: Jun. 11, 2026

(54) METHOD AND WIRELESS COMMUNICATION SYSTEM FOR GNB-UE TWO SIDE CONTROL OF ARTIFICIAL INTELLIGENCE/MACHINE LEARNING MODEL

(71) Applicant: Continental Automotive Technologies GmbH, Hannover (DE)

(72) Inventors: Hojin Kim, Regensburg (DE); Rikin Shah, Langen (DE); David Gonzalez Gonzalez, Egelsbach (DE); Andreas Andrae, Frankfurt am Main (DE); Osvaldo Gonsa, Frankfurt (DE)

(73) Assignee: Continental Automotive Technologies GmbH, Hannover (DE)

(21) Appl. No.: 19/124,303

(22) PCT Filed: Oct. 25, 2023
(86) PCT No.: PCT/EP2023/079706

§ 371 Date: Apr. 25, 2025

(30) Foreign Application Priority Data
Oct. 25, 2022 (DE) 10 2022 211 315.2

(51) Int. Cl. H04L 41/16; H04W 24/10

(52) U.S. Cl. CPC H04L 41/16; H04W 24/10

(57) ABSTRACT

Method for gNB-UE two side model control by a user equipment (UE) device receiving an artificial intelligence (AI) and/or machine learning (ML) model status information from at least one base-station (gNB) within a wireless communication network, wherein after receiving the artificial intelligence (AI) and/or machine learning (ML) model status information the user equipment (UE) decides if the an artificial intelligence (AI) and/or machine learning (ML) model status information is activated, the user equipment (UE) maintains in the same artificial intelligence (AI) and/or machine learning (ML) model status information, if the artificial intelligence (AI) and/or machine learning (ML) model status information is deactivated, the user equipment (UE) switches to an alternative operation mode based on assistance information from base-station (gnB).

### CROSS-REFERENCE TO RELATED APPLICATIONS

The present application is a National Stage Application under 35 U.S.C. § 371 of International Patent Application No. PCT/EP2023/079706 filed on Oct. 25, 2023, and claims priority from German Patent Application No. 10 2022 211 315.2 filed on Oct. 25, 2022, in the German Patent and Trademark Office, the disclosures of which are herein incorporated by reference in their entireties.

### TECHNICAL FIELD

The present disclosure relates to gNb UE two side model control.

### BACKGROUND

The Third Generation Partnership Project (3GPP) has standardized Coverage Enhancement (CE) for Internet-of-Things (IoT) to connect devices in challenging radio conditions with cellular networks. CE is based on the principle of prolonged transmission time that exploits the fact that many IoT applications have relaxed requirements on data rate and latency, and the coverage can be significantly boosted by repeating transmissions for such applications. However, CE consumes a lot of radio resources and should be implemented carefully for different applications.

Evolution of wireless communication technologies toward the fifth-generation (5G) enables everything to be connected through the internet. For example, lots of information related to human activities have been recorded, monitored through various types of IoT applications (e.g., health monitoring, smart home, intelligent transportation, industrial automation), and exchanged through cellular networks. However, unfortunately, conventional cellular networks have not been designed to accommodate such diverse IoT applications. Accordingly, enormous efforts have been made to support the emerging IoT scenario in cellular networks, which is referred to massive machine-type communications (mMTC) or massive IoT (mIoT) as one of the main use cases of 5G.

In cellular networks, an extremely large number of IoT devices are expected to be deployed, where the number of connected devices will reach 500 billion by 2030. Each IoT device sporadically generates small-sized packets to report sensing information to the IoT server through a base station (BS/gNB). In particular, an IoT device stays out-of-connection with the BS to reduce energy consumption due to the sporadic packet generation. This implies that each of IoT devices should perform random access (RA) procedure to establish a connection with the BS, whenever transmitting data packets to the IoT server. The RA procedure adopted in the existing cellular systems such as LTE/LTE-A/5G consists of four-steps of handshaking procedure. Due to the densely deployed IoT devices in cellular IoT networks, simultaneous RA attempts at a certain RA slot (or, equivalently, physical RA channel (PRACH)) may cause collision problem. Collision problem highly causes the poor access performance (i.e., RA failure) at the device side. To be specific, IoT devices may spend considerable time to access the networks and thus the networks cannot guarantee acceptable end-to-end delay according to their access priority.

In cellular systems, a connection between each IoT device and the BS is pre-required for data communications. For establishing a connection, a device should proceed 4-steps of RA procedure. It is summarized that the overall descriptions on the conventional RA procedure in cellular networks (e.g., LTE/LTE-A/5G) is as follows
Step1. Preamble transmissions: Each IoT device randomly selects a single RA preamble among a set of available RA preambles, and transmits it on the PRACH.
Step2. Random access responses: The BS detects which preambles are active. In response to the detected preambles, the BS transmits random access response (RAR) messages, each of which consists of an RA preamble identifier (RAPID), a timing alignment (TA), an uplink grant (UG), and a temporary identifier. Each IoT device which transmitted a preamble at the first step waits for the RAR message containing the same RAPID. If there exists the corresponding RAR message, each device utilizes information within the message for the subsequent step (i.e., Step3).
Step3. Scheduled transmissions: Each IoT device transmits its scheduled message (e.g., connection request message) on the assigned uplink resource on physical uplink shared channel (PUSCH), indicated by the UG value contained in the RAR message received in the second step. In order to determine whether the resource collision on the used uplink resource occurs or not, each IoT device starts a contention resolution (CR) timer once the Step3 message is transmitted.
Step4. Acknowledgement: The BS echoes the identifiers of the IoT devices, whose transmitted scheduled messages are successfully decoded without any resource collisions. If each IoT device receives the correct acknowledgement (ACK) message before the CR timer expires, then it regards the RA attempt as a success. Otherwise, it regards the RA attempt as a failure and reattempts the RA procedure at the next-available RA slot after performing a back-off.

US 2019/0156247 describes techniques for dynamic accuracy-based experimentation and deployment of machine learning (ML) models. Inference traffic flowing to ML models and the accuracy of the models is analyzed and used to ensure that better performing models are executed more often via model selection. A predictive component can evaluate which model is more likely to be accurate for certain input data elements. Ensemble techniques can combine inference results of multiple ML models to aim to achieve a better overall result than any individual model could on its own.

US 2019/0095756 describes techniques for selection of machine learning algorithms based on performance predictions by trained algorithm-specific regressors. In an embodiment, a computer derives meta-feature values from an inference dataset by, for each meta-feature, deriving a respective meta-feature value from the inference dataset. For each trainable algorithm and each regression meta-model that is respectively associated with the algorithm, a respective score is calculated by invoking the meta-model based on at least one of: a respective subset of meta-feature values, and/or hyperparameter values of a respective subset of hyperparameters of the algorithm. The algorithm(s) are selected based on the respective scores. Based on the inference dataset, the selected algorithm(s) may be invoked to obtain a result. In an embodiment, the trained regressors are distinctly configured artificial neural networks. In an embodiment, the trained regressors are contained within algorithm-specific ensembles. Techniques are also provided for optimal training of regressors and/or ensembles.

US 2021/0328630 describes methods, systems, and devices for wireless communications in which a base station may develop a number of different predictive models for each of a number of different functions. The different functions may be used to determine various beamforming parameters for beamformed communications between a user equipment (UE) and a base station. The base station may provide the models to a UE, and the UE may then use such models to determine values for one or more beamforming parameters. A same function (e.g., a beam prediction function to identify a transmit/receive beam for communications) may have multiple different models, which may be provided to the UE by the base station, which may be used based on particular channel conditions or locations of a UE. The UE or base station may select which model of the multiple predictive models is to be used for communications.

WO 2020/245639 discloses a system for predicting faults in a cloud computing environment. The system includes a model selection module configured to: train a plurality of candidate models using offline data of the cloud computing environment; and select one of more of the trained candidate models based at least in part on a respective training result of each trained candidate model. An online predictor is configured to predict faults in the cloud computing environment based on the selected trained candidate models and online data of the cloud computing environment.

KR 20200141835 discloses a device for generating a model, which learns a data set in a distributed environment, comprises: a model generation unit generating a local model learning a local data set; a model selection unit selecting a global model, which is previously learned and stored; and a model association unit associating the local model and the global model to generate a federation model. Therefore, learning model performance can be improved with optimal model generation.

US 2019220758 describes a distributed system for training a classifier. The system comprises machine learning (ML) workers and a parameter server (PS). The PS is configured for parallel processing to provide the model to each of the ML workers, receive model updates from each of the ML workers, and iteratively update the model using each model update. The PS contains gradient datasets associated with a respective ML worker, for storing a model-update-identification (delta-M-ID) indicative of the computed model update and the respective model update, a global dataset that stores, the delta-M-ID, an identification of the ML worker (ML-worker-ID) that computed the model update, and a model version that marks a new model in PS that is computed from merging the model update with a previous model in PS; and a model download dataset that stores the ML-worker-ID and the model version of each transmitted model.

US 2022083911 describes a user equipment. A user equipment includes a processor configured to download a master machine learning model for generating a user recommendation related to use of an application of the user equipment, calculate a model update for the master machine learning model using the master machine learning model and data related to one or more of a user of the user equipment or a user interaction with the user equipment, encode the calculated model update using an ε-differential privacy mechanism and transmit the ε-differential privacy encoded model update.

US 2022012601 describes a Federated learning server and a method. The Federated learning server is configured to aggregate a plurality of received model updates to update a master machine learning model. Once a pre-defined threshold or interval for received model updates is reached, a set of current hyper-parameter values and corresponding validation set performance metrics obtained from the updated master machine learning model are sent to a hyper-parameter optimization model. The optimization model infers the next set of optimal hyper-parameters using pairwise history of hyper-parameter values and the corresponding performance metrics. The inferred hyper-parameter values are sent to the Federated Learning server which updates the master machine learning model with the updated set of hyper-parameter values and redistributes the updated master machine learning model with the updated set of hyper-parameter values. According to the application, hyper-parameter optimization in a Federated learning mode can be realized to provide accurate personalized recommendations.

US 2022198337 describes an information processing system. The information processing system obtains a training data set including input data and a label, which is ground truth data for the input data, training a machine learning model on the training data set, inputs test data to the machine learning model trained on the training data set, evaluates whether performance of the machine learning model satisfies a predetermined condition based on an output of the machine learning model to which the test data is entered, updates the training data set when the performance of the machine learning model is evaluated not to satisfy the predetermined condition, and retrains the machine learning model on the updated training data set. The information processing system repeats updating, retraining, and evaluating the data set in response to the evaluation.

WO 2021032496 describes a method performed by a first network entity in a communications network. The method comprises training a model to obtain a local model update comprising an update to values of one or more parameters of the model, in which training the model comprises inputting training data into a machine learning algorithm. The method further comprises applying a serialisation function to the local model update to construct a serial representation of the local model update, thereby removing information indicative of a structure of the model, and transmitting the serial representation of the local model update to an aggregator entity in the communications network.

US 2022182263 describes an OAM core network. An OAM core network may receive a request for a ML/NN model and features associated with a ML/NN procedure. The OAM core network may determine a latest update to the ML/NN model and features based on the request and generate a response to the request indicative of the latest update to the ML/NN model and features. In aspects, a base station may initiate the request for the ML/NN model and features by transmitting the request for the ML/NN model and features to the OAM core network. The base station may receive the generated response of the OAM core network based on the transmitted request. In further aspects, a UE may initiate the request for the ML/NN model and features by transmitting the request to the base station, where the UE may receive the ML/NN model and features from the base station based on the transmitted request.

WO 2021252981 describes techniques for authenticating a user based on a machine learning model, including receiving user authentication data associated with a user; generating output from a neural network model based on the user authentication data; determining a distance between the output and an embedding vector associated with the user; comparing the determined distance to a distance threshold; and making an authentication decision based on the comparison.

The terminologies of working list contains a set of high-level descriptions about AI/ML model training, inference, validation, testing, UE-side (AI/ML) model, network-side (AI/ML) model, one-sided (AI/ML) model, two-sided (AI/ML) model, etc. In this application common abbreviation like AI: artificial intelligence, ML: machine learning and NR: new radio are used.

All signaling aspects to support the above items are currently not specified yet as definitions of terminologies are still under discussion for further modifications.

Any potential standards impact with new or enhanced mechanisms of supporting AI/ML model with the above working list items is one of key areas for investigation in AI/ML study item.

In two-sided AI/ML model, joint inferencing is performed between UE and gNB. As both AI/ML models in gNB and UE are executed collaboratively, UE might have the model performance impact when joint inferencing is unexpectedly stopped before any pre-configured timing or end of operation period with gNB model deactivation if UE-specific behavior is not specified for this occurrence.

For example, the model deactivation of gNB side can be based on the following reasons. Link quality degradation not to meet joint inferencing connection or joint inferencing operation of gNB model without any configured timer or time duration to support two-sided AI/ML model phase or early drop of two-sided AI/ML model phase due to gNB network issues.

Generally spoken a new signaling message from gNB and the associated UE behavior specification is proposed where UE determines the behaviors of model operation.

The main of goal of this application is to give a solution the prosed problem.

The proposed idea can improve reliability of model performance and contribute to the required changes for two-sided model based gNB-UE signaling and UE behavior.

### BRIEF SUMMARY

The described problem is solved by the embodiments of this application.

A particular embodiment is characterized by the method for gNB-UE two side model control by a user equipment (UE) device receiving an artificial intelligence (AI) and/or machine learning (ML) model status information from at least one base-station (gNB) within a wireless communication network. After receiving the artificial intelligence (AI) and/or machine learning (ML) model status information the user equipment (UE) decides, if the an artificial intelligence (AI) and/or machine learning (ML) model status information is activated, the user equipment (UE) maintains in the same artificial intelligence (AI) and/or machine learning (ML) model status information, if the artificial intelligence (AI) and/or machine learning (ML) model status information is deactivated, the user equipment (UE) switches to an alternative operation mode based on assistance information from base-station (gNB).

According to certain embodiment the method for gNB-UE two side model control by a user equipment (UE), wherein the artificial intelligence (AI) and/or machine learning (ML) model status information comprises model status indication, model transfer information and user equipment (UE) behavior index from base-station (gNB).

A particular embodiment is characterized by the method for gNB-UE two side model control by a base station (gNB) in a wireless communication network, wherein the method comprises:
Determination of an artificial intelligence (AI) and/or machine learning (ML) model status information
Checking the status of the artificial intelligence (AI) and/or machine learning (ML) model status information by the base-station (gNB),
if the checking results in the non-deactivation of base-station (gNB) the artificial intelligence (AI) and/or machine learning (ML) model status information remains in the same the artificial intelligence (AI) and/or machine learning (ML) model status information and artificial intelligence (AI) and/or machine learning (ML) model status information is used for further proceedings,
if the check results in the deactivation of the artificial intelligence (AI) and/or machine learning (ML) model status information, the artificial intelligence (AI) and/or machine learning (ML) model status information is transmitted via the base station (gNB) to at least one user equipment (UE).

A certain embodiment is characterized by method for gNB-UE two side model control by a base station (gNB) in a wireless communication network, wherein the artificial intelligence (AI) and/or machine learning (ML) model status information comprises model status indication, model transfer information and user equipment (UE) behavior index from base-station (gNB).

A certain embodiment is characterized by method for gNB-UE two side model control between at least a user equipment (UE) and a base station (gNB) in a wireless communication network comprising an artificial (AI) and/or machine learning (ML) model training phase and an artificial (AI) and/or machine learning (ML) model inferencing phase.

A certain embodiment is characterized by method according for gNB-UE two side model control between at least a user equipment (UE) and a base station (gNB) in a wireless communication network comprising an artificial (AI) and/or machine learning (ML) model training phase and an artificial (AI) and/or machine learning (ML) model inferencing phase, wherein the artificial (AI) and/or machine learning (ML) model inferencing phase comprises the steps:
Transmitting a measurement report and/or user equipment (UE) capability for artificial (AI) and/or machine learning (ML) from a user equipment (UE) to the base-station (gNB)
   Transmitting a parameter configuration update for artificial (AI) and/or machine learning (ML) from the base-station (gNB) to at least a user equipment (UE)
   Performing artificial (AI) and/or machine learning (ML) model inferencing by the base-station (gNB) and at least a user equipment (UE)
   Data exchange for model transfer and/or inference output between base-station (gNB) and at least one user equipment (UE)
   Model performance monitoring feedback exchange between base-station (gNB) and at least one user equipment (UE).

A particular embodiment is characterized by wherein the method for gNB-UE two side model control between at least a user equipment (UE) and a base station (gNB) in a wireless communication network comprising an artificial (AI) and/or machine learning (ML) model inferencing phase comprising the steps:
Determination of model status change and user equipment (UE) behavior index
Generation of a model transfer information
Creating an artificial (AI) and/or machine learning (ML) assistance information, wherein the artificial (AI) and/or machine learning (ML) assistance information comprises model status indication, model transfer information, user equipment (UE) behaviour index
Transmitting the artificial (AI) and/or machine learning (ML) assistance information to at least one user equipment (UE),
Switching to the alternative operation mode based on the artificial (AI) and/or machine learning (ML) assistance information by the user equipment (UE)
Transmitting user equipment (UE) behaviour update report from the user equipment (UE) to the base-station (gNB).

A certain embodiment is characterized by apparatus for gNB-UE two side model control between a user equipment (UE) and a base-station (gNB) in a wireless communication network, the apparatus comprising a wireless transceiver, a processor coupled with a memory in which computer program instructions are stored, said instructions being configured to implement steps of the claims 1 to 7.

A certain embodiment is characterized by user equipment (UE) comprising an apparatus described above.

A certain embodiment is characterized by base station (gNB) comprising an apparatus described above

A certain embodiment of the method is implemented in a base station (gNB) in a wireless communication network, is characterized by steps: Receiving a random access (RA) request Coverage Enhancement (CE) a notification to a user equipment (UE) is in connected mode,
user equipment (UE) decides whether to switch to alternative network or not based on overall network congestion, whereby this decision information is determined by reaching the maximum of random access (RA) procedure failure for a Coverage Enhancement (CE) level (k), in case the maximum of random access (RA) procedure failure for a Coverage Enhancement (CE) level (k) is reached, a check if the user equipment (UE) triggered handover to alternative network should be proceeded is done, if the result of the check is positive, then the handover to alternative network is proceeded, if the result of the check is negative, then the user equipment (UE) stays in the same network and upgrades to Coverage Enhancement (CE) level (k) to the level (k+1) for random access (RA) procedure, whereby the base-station (gNB) configures whether user equipment (UE) is to switch to alternative network.

A certain embodiment of the method proceeded by a base station (gNB) in a wireless communication network, is characterized by the steps:
Receiving a random access (RA) request Coverage Enhancement (CE) a notification to a user equipment (UE) is in connected mode,
user equipment (UE) decides whether to switch to alternative network or not based on overall network congestion, whereby this decision information is determined by reaching the maximum of random access (RA) procedure failure for a Coverage Enhancement (CE) level (k), in case the maximum of random access (RA) procedure failure for a Coverage Enhancement (CE) level (k) is reached, a check if the user equipment (UE) triggered handover to alternative network should be proceeded is done, if the result of the check is positive, then the handover to alternative network is proceeded, if the result of the check is negative, then the user equipment (UE) stays in the same network and upgrades to Coverage Enhancement (CE) level (k) to the level (k+1) for random access (RA) procedure, whereby the base-station (gNB) configures whether user equipment (UE) is to switch to alternative network.

A certain embodiment is characterized by a wireless communication system for gNB-UE two side model control from a base station to a user equipment, wherein the base station comprises a processor coupled with a memory in which computer program instructions are stored, said instructions being configured to implement steps of claims 4 to 7, wherein the user equipment (UE) comprises a processor coupled with a memory in which computer program instructions are stored, said instructions being configured to implement steps of the claims 1 to 3.

A certain embodiment is characterized by a wireless communication system for performing for Energy Efficient Coverage Enhancement according, whereby a user equipment (UE) triggered handover is performed after the user equipment (UE) takes a handover decision information based on a defined criteria from at least one cell A to at least another cell B, after the following steps are performed:
the user equipment (UE) sends a random access (RA) request Coverage Enhancement (CE) level (k) to a cell A, cell A sends a random access (RA) failure Coverage Enhancement (CE) level (k) back to the user equipment (UE) and waits for user equipment (UE) to get connected with higher Coverage Enhancement (CE) level (k) the user equipment (UE) sends a random access (RA) request Coverage Enhancement (CE) level (k) to a cell B, and if there is no random access (RA) possible for the user equipment (UE), Cell A buffers the data of the user equipment (UE), cell B sends a random access (RA) response Coverage Enhancement (CE) level (k) back to the user equipment (UE) user equipment (UE) and cell B are connected cell B updates user equipment (UE) details, if cell A gets an update from cell B regarding the user equipment (UE), cell A transfers the user equipment (UE) data to cell, if cell A gets no updates from other cells about the user equipment (UE) cell A declares radio link failure (RLF).

The information medium may be any entity or device capable of storing the program. For example, the medium can comprise a storage means, such as a ROM, for example a CD ROM or a microelectronic circuit ROM, FLASH memory or any magnetic recording means, for example a hard drive.

Moreover, the information medium may be a transmissible medium such as an electrical or optical signal, which may be conveyed via an electrical or optical cable, by radio or by other means.

Alternatively, the information medium may be an integrated circuit into which the program is incorporated, the circuit being adapted to execute or to be used in the execution of the methods in question.

The advantages of the apparatus, user equipment, wireless system, computer program and information medium are identical to those presented in relation with the corresponding method according to any one of the embodiments mentioned hereinabove.

### BRIEF DESCRIPTION OF THE DRAWINGS

Other advantages and characteristics of the invention will be more clearly apparent on reading the following description, given by way of simple illustrative and nonlimiting example, and the appended drawings.

FIG. 1. shows the gNB behaviour.

FIG. 2. Shows the user equipment (UE) behavior.

FIG. 3. shows the two-sided model inferencing signaling flow.

FIG. 4. shows the user equipment (UE) behavior signaling flow.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

Narrowband Internet of things (NB-IoT) is a low-power wide-area network (LPWAN) radio technology standard developed by 3GPP for cellular devices and services. The specification was frozen in 3GPP Release 13 (LTE Advanced Pro), in June 2016. Other 3GPP IoT technologies include eMTC (enhanced Machine-Type Communication) and EC-GSM-IoT. NB-IoT focuses specifically on indoor coverage, low cost, long battery life, and high connection density. NB-IoT uses a subset of the LTE standard, but limits the bandwidth to a single narrow-band of 200 kHz. It uses OFDM modulation for downlink communication and SC-FDMA for uplink communications. IoT applications which require more frequent communications will be better served by NB-IoT, which has no duty cycle limitations operating on the licensed spectrum.

Coverage Enhancement is to provide reliable connections with extended coverage, a retransmission, repetition, and power ramping schemes and CE groups are introduced into NB-IoT during both RACH procedure and data transmission procedure. Retransmission means repetition of RA request in case of no RA response. Repetition means repetition of preambles to improve the probability of detection at gNB. Power ramping means increase transmit power level to compensate higher path loss.

The wireless communications system may include one or more base stations, one or more UEs, and a core network. In some examples, the wireless communications system may be a Long Term Evolution (LTE) network, an LTE-Advanced (LTE-A) network, an LTE-A Pro network, or a New Radio (NR) network. In some examples, the wireless communications system may support enhanced broadband communications, ultra-reliable (e.g., mission critical) communications, low latency communications, communications with low-cost and low-complexity devices, or any combination thereof.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures.

For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

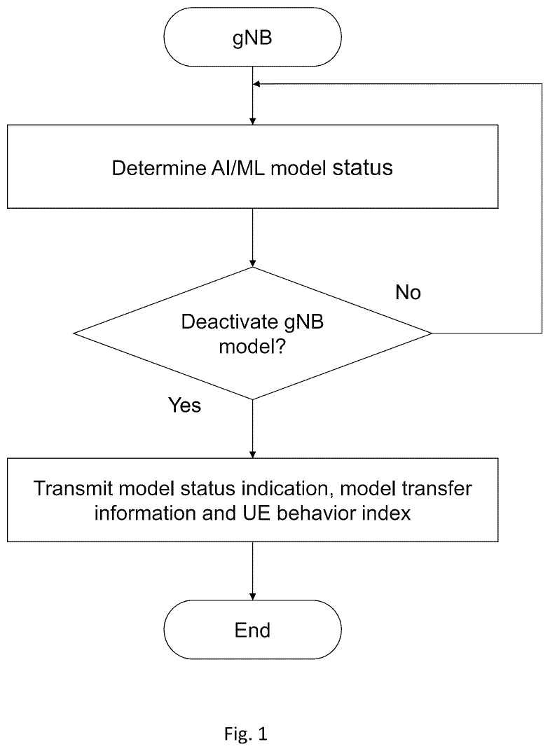

FIG. 1. shows the gNB behaviour. gNB sends deactivation message of gNB-based AI/ML model (as model status indication) through PDCCH/MAC CE (UE specific) and system information (to all UEs) for UE(s) who are participants for two-sided AI/ML model operation.
Specifically, 1 bit is used for model status indication:
“0”->activate and
“1”->deactivate

In addition, model transfer information (e.g., the configured parameters of gNB-based AI/ML model) is sent to UE(s) along with deactivation message—optionally.

The configurable criteria to determine deactivation of AI/ML model in gNB is set by network.

In case of event-triggering, the triggering mechanism for gNB model deactivation can be based on the pre-configured KPIs such as model performance level, model drift, etc along with any threshold specification.

The base stations may be dispersed throughout a geographic area to form the wireless communications system and may be devices in different forms or having different capabilities. The base stations and the UEs may wirelessly communicate via one or more communication links. Each base station may provide a coverage area over which the UEs and the base station may establish one or more communication links. The coverage area may be an example of a geographic area over which a base station and a UE may support the communication of signals according to one or more radio access technologies.

The UEs may be dispersed throughout a coverage area of the wireless communications system, and each UE may be stationary, or mobile, or both at different times. The UEs may be devices in different forms or having different capabilities. The UEs described herein may be able to communicate with various types of devices, such as other UEs, the base stations, or network equipment (e.g., core network nodes, relay devices, integrated access and backhaul (IAB) nodes, or other network equipment).

The base stations may communicate with the core network, or with one another, or both. For example, the base stations may interface with the core network through one or more backhaul links (e.g., via an S1, N2, N3, or other interface). The base stations may communicate with one another over the backhaul links (e.g., via an X2, Xn, or other interface) either directly (e.g., directly between base stations), or indirectly (e.g., via core network), or both. In some examples, the backhaul links may be or include one or more wireless links.

One or more of the base stations described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE may include or may be referred to as a mobile device, a wireless device, a remote device, a handheld device, or a subscriber device, or some other suitable terminology, where the “device” may also be referred to as a unit, a station, a terminal, or a client, among other examples. A UE may also include or may be referred to as a personal electronic device such as a cellular phone, a personal digital assistant (PDA), a tablet computer, a laptop computer, or a personal computer. In some examples, a UE may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs described herein may be able to communicate with various types of devices, such as other UEs that may sometimes act as relays as well as the base stations and the network equipment including macro eNBs or gNBs, small cell eNBs or gNBs, or relay base stations, among other examples, as shown in FIG. 1.

The UEs and the base stations may wirelessly communicate with one another via one or more communication links over one or more carriers. The term “carrier” may refer to a set of radio frequency spectrum resources having a defined physical layer structure for supporting the communication links. For example, a carrier used for a communication link may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system may support communication with a UE using carrier aggregation or multi-carrier operation. A UE may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE receives and the higher the order of the modulation scheme, the higher the data rate may be for the UE. A wireless communications resource may refer to a combination of a radio frequency spectrum resource, a time resource, and a spatial resource (e.g., spatial layers or beams), and the use of multiple spatial layers may further increase the data rate or data integrity for communications with a UE.

The time intervals for the base stations or the UEs may be expressed in multiples of a basic time unit which may, for example, refer to a sampling period of Ts=1/(Δfmax·Nf) seconds, where Δfmax may represent the maximum supported subcarrier spacing, and Nf may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots.

Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs. For example, one or more of the UEs may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs and UE-specific search space sets for sending control information to a specific UE.

In some examples, a base station may be movable and therefore provide communication coverage for a moving geographic coverage area. In some examples, different geographic coverage areas associated with different technologies may overlap, but the different geographic coverage areas may be supported by the same base station. In other examples, the overlapping geographic coverage areas associated with different technologies may be supported by different base stations. The wireless communications system may include, for example, a heterogeneous network in which different types of the base stations provide coverage for various geographic coverage areas using the same or different radio access technologies.

The wireless communications system may be configured to support ultra-reliable communications or low-latency communications, or various combinations thereof. For example, the wireless communications system may be configured to support ultra-reliable low-latency communications (URLLC) or mission critical communications. The UEs may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE may also be able to communicate directly with other UEs over a device-to-device (D2D) communication link (e.g., using a peer-to-peer (P2P) or D2D protocol). One or more UEs utilizing D2D communications may be within the geographic coverage area of a base station. Other UEs in such a group may be outside the geographic coverage area of a base station or be otherwise unable to receive transmissions from a base station. In some examples, groups of the UEs communicating via D2D communications may utilize a one-to-many (1: M) system in which each UE transmits to every other UE in the group. In some examples, a base station facilitates the scheduling of resources for D2D communications. In other cases, D2D communications are carried out between the UEs without the involvement of a base station.

The core network may provide user authentication, access authorization, tracking, Internet Protocol (IP) connectivity, and other access, routing, or mobility functions. The core network may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs served by the base stations associated with the core network. User IP packets may be transferred through the user plane entity, which may provide IP address allocation as well as other functions. The user plane entity may be connected to the network operators IP services. The operators IP services may include access to the Internet, Intranet(s), an IP Multimedia Subsystem (IMS), or a Packet-Switched Streaming Service.

Some of the network devices, such as a base station, may include subcomponents such as an access network entity, which may be an example of an access node controller (ANC). Each access network entity may communicate with the UEs through one or more other access network transmission entities, which may be referred to as radio heads, smart radio heads, or transmission/reception points (TRPs). Each access network transmission entity may include one or more antenna panels. In some configurations, various functions of each access network entity or base station may be distributed across various network devices (e.g., radio heads and ANCs) or consolidated into a single network device (e.g., a base station).

The wireless communications system may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system may utilize both licensed and unlicensed radio frequency spectrum bands. For example, the wireless communications system may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations and the UEs may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station or a UE may be equipped with multiple antennas, which may be used to employ techniques such as transmit diversity, receive diversity, multiple-input multiple-output (MIMO) communications, or beamforming. The antennas of a base station or a UE may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station may be located in diverse geographic locations. A base station may have an antenna array with a number of rows and columns of antenna ports that the base station may use to support beamforming of communications with a UE. Likewise, a UE may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station, a UE) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference.

The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system includes base stations, UEs, satellites, and a core network. In some examples, the wireless communications system may be an LTE network, an LTE-A network, an LTE-A Pro network, or a NR network. In some cases, wireless communications system may support enhanced broadband communications, ultra-reliable (e.g., mission critical) communications, low latency communications, or communications with low-cost and low-complexity devices.

Wireless communications system may also include one or more satellites. Satellite may communicate with base stations (also referred to as gateways in NTNs) and UEs (or other high altitude or terrestrial communications devices). Satellite may be any suitable type of communication satellite configured to relay communications between different end nodes in a wireless communication system. Satellite may be an example of a space satellite, a balloon, a dirigible, an airplane, a drone, an unmanned aerial vehicle, and/or the like. In some examples, the satellite may be in a geosynchronous or geostationary earth orbit, a low earth orbit or a medium earth orbit. A satellite may be a multi-beam satellite configured to provide service for multiple service beam coverage areas in a predefined geographical service area. The satellite may be any distance away from the surface of the earth.

In some cases, a cell may be provided or established by a satellite as part of a non-terrestrial network. A satellite may, in some cases, perform the functions of a base station, act as a bent-pipe satellite, or may act as a regenerative satellite, or a combination thereof. In other cases, satellite may be an example of a smart satellite, or a satellite with intelligence. For example, a smart satellite may be configured to perform more functions than a regenerative satellite (e.g., may be configured to perform particular algorithms beyond those used in regenerative satellites, to be reprogrammed, etc.). A bent-pipe transponder or satellite may be configured to receive signals from ground stations and transmit those signals to different ground stations. In some cases, a bent-pipe transponder or satellite may amplify signals or shift from uplink frequencies to downlink frequencies. A regenerative transponder or satellite may be configured to relay signals like the bent-pipe transponder or satellite, but may also use on-board processing to perform other functions. Examples of these other functions may include demodulating a received signal, decoding a received signal, re-encoding a signal to be transmitted, or modulating the signal to be transmitted, or a combination thereof. For example, a bent-pipe satellite (e.g., satellite) may receive a signal from a base station and may relay the signal to a UE or base station, or vice-versa. In accordance with various aspects of the present disclosure, coverage enhancement for communications with satellites may be provided through repetitions of communications, which may reduce BLER and enhance communications reliability.

A UE may include a UE communications manager. The UE communications manager may receive from a base station or a satellite, an indication of a repetition activation for communications. The UE communications manager may determine, responsive to the repetition indication, resources for communications that contain repetitions. When receiving communications, the UE communications manager may buffer signals from resources containing multiple transmissions, and attempt to decode the associated communication. In some cases, when transmitting an uplink message to the base station or the satellite, the UE communications manager may prepare multiple repetitions of the communication based on the configured repetitions. Further, in some cases, uplink messages may be transmitted using a smaller frequency bandwidth than a full channel bandwidth, in order to provide a higher power density and enhance the likelihood of reception of the uplink message.

A base station may include a base station communications manager. The base station communications manager may configure a coverage enhancement scheme at one or more UEs in which a number of repetitions of communications are provided to help reduce BLER. Repetitions may be provided through slot bundling for PDCCH in consecutive or non-consecutive slots, or through multiple repetitions within the same slot.

Coverage Enhancement: CE is achieved through repetition in time, retransmission, and power-boosting in-band and guard band operating modes. The coverage extension feature of NB-IoT is handy when the sensors are located in remote or challenging areas. Reliable coverage enhancement is achieved by the repeated transmission of data and control signaling. Each transmission can be configured to repeat for a designated number of times in order to achieve higher success opportunities at the desired coverage level.

Number of repetition value is directly proportional to Maximum Coupling Loss (MCL).

Number of repetitions will improve the SNR at the receiver. Increase in number of repetitions results in increase in energy consumption. Large repetition number results in higher latency. CE will result in radio resource wastage (UE occupies a channel for longer duration in case of higher-level CE). CE is suitable for latency insensitive applications (applications that can tolerate 10 seconds of transmission delay). Avoiding CE upgradation with any alternative can improve energy efficiency and reduce radio resource wastage.

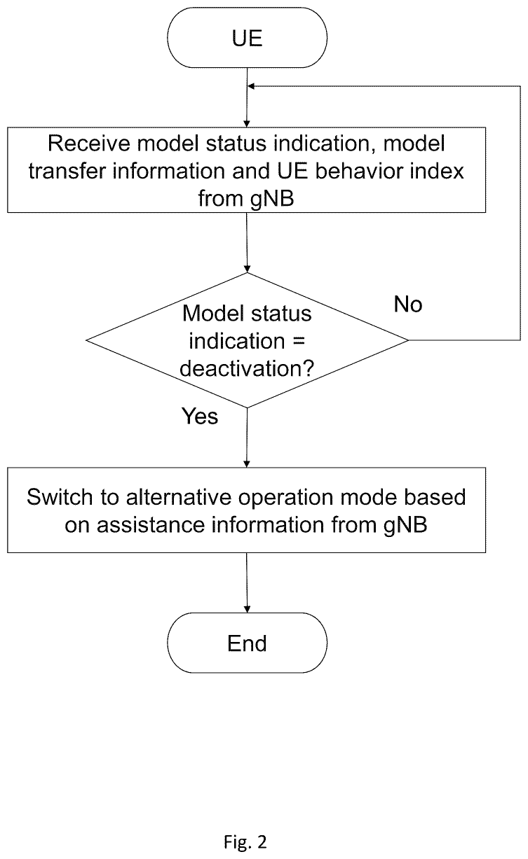

FIG. 2. shows the user equipment (UE) behavior. New signaling is required to define UE behavior when it receives deactivation signal from gNB. Specifically, 2 bit is used for UE behavior index:
“00” (UE behavior #1)->Configured model from gNB
“01” (UE behavior #2)->UE-sided model
“10” (UE behavior #3)->Fallback (non-AI/ML operation)
“11” (UE behavior #4)->Reserved
   gNB can configure same behavior to all UEs (through system information) and/or UE specific behavior through dedicated RRC message (e.g., RRC Reconfiguration message). In the periodic way, gNB can signal deactivation message based on the specific time period X (ms) or specific time slot Y where value X and Y are indicated in the system information message or dedicated RRC message.

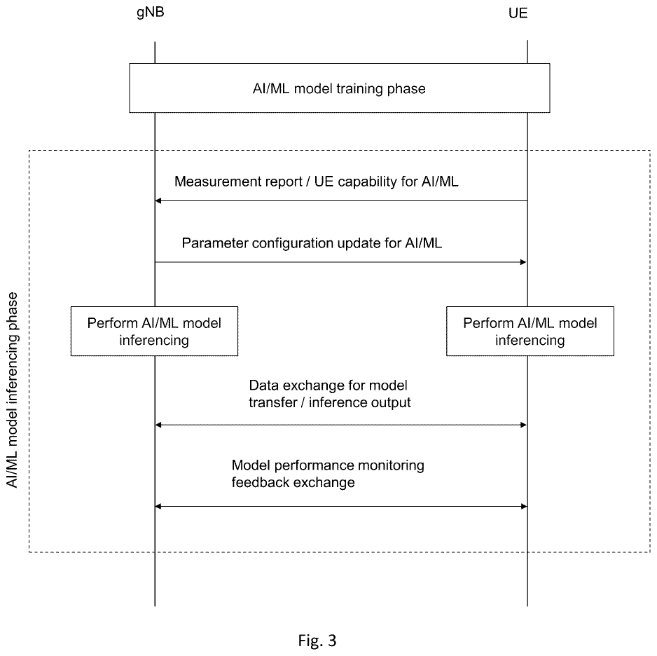

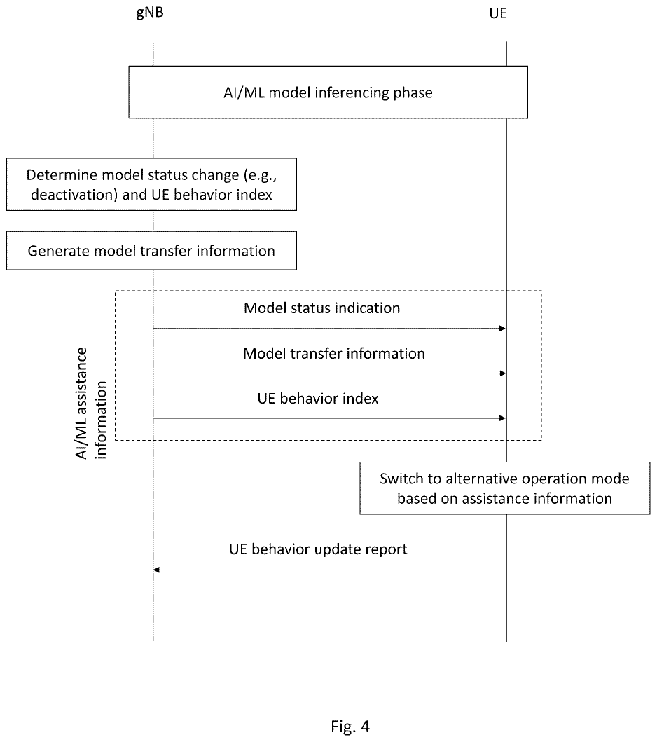

FIG. 3. shows the two-sided model inferencing signaling flow and FIG. 4. shows the user equipment (UE) behavior signaling flow.

When two-sided model operation for joint inferencing is collapsed due to model deactivation without receiving assistance information from gNB, UE can then automatically switch to UE-side model or fallback mode as well.

UE behavior update report is transmitted to gNB then.

Without gNB signaling, mode switching in UE is determined based on the criteria using the pre-configured threshold with KPIs (e.g. UE-model performance, UE AI/ML capability status, etc.) .

During joint inferencing phase, joint model parameter updates can be performed between gNB and UEs through online-federated learning.

In two-sided model with separate models in use on network and UE sides, network sided model can be located in serving cell and/or cloud computing server.

With the associated serving cell, the connected neighbor cells can be configured to assist gNB-UE joint inferencing in two-sided model such as inferencing computation or model transfer information. Those assisting neighbor cells can support some of UEs in mobility during joint inferencing phase based on communication between serving cell and neighbor cells.

In one first additional embodiment the gNB sends deactivation message of gNB-based AI/ML model with 1 bit through PDCCH/MAC CE (UE specific) and system information (to all UEs).

In a second additional embodiment the gNB sends UE behavior configuration information with 2 bits to define UE behavior for all UEs (through system information) and/or UE specific behavior through dedicated RRC message (e.g., RRC Reconfiguration message) when sending deactivation message.

In a third additional embodiment gNB sends model transfer information (e.g., the configured parameters of gNB-based AI/ML model) to UE(s) when sending deactivation message.

In a fourth additional embodiment gNB can signal deactivation message to specific time period X (ms) or specific time slot Y where value X and Y are indicated in the system information message or dedicated RRC message.

In a fifth additional embodiment mode switching in UE can be also determined based on the criteria using the pre-configured threshold with KPIs (e.g. UE-model performance, UE AI/ML capability status, etc.) when no assistance information from gNB is received so that UE can then automatically switch to UE-side model or fallback mode as well.

In a sixth additional embodiment during joint inferencing phase, joint model parameter updates can be performed between gNB and UEs through online-federated learning.

In a seventh additional embodiment the connected neighbor cells can be configured to assist gNB-UE joint inferencing in two-sided model to support inferencing computation or model transfer information including mobility UEs during joint inferencing phase.

The core aspect of this new method is to create a mechanism where UE takes decision, whether to upgrade to higher level of CE or to switch the network (TN to NTN or NTN to TN) in case of reaching maximum RA procedure failure. UE (NB-IoT) can consider utilizing the NTN before upgrading to the higher-level CE (CE 1, CE 2) when it is initially connected to TN. UE (NB-IoT) can consider utilizing the TN before upgrading to the higher-level CE (CE 1, CE 2) when it is initially connected to NTN.

Method is connected to a wireless communication network, wherein the user equipment (UE) decides to upgrade to higher level of Coverage Enhancement (CE) or to switch the network in case of reaching maximum Random Access (RA) procedure failure. User equipment (UE) is in idle mode, user equipment (UE) decides whether to switch to alternative network or not based on overall network congestion, whereby this information is indicated by the network, by reaching the maximum of random access (RA) procedure failure for a Coverage Enhancement (CE) level (k), cell selection on alternative networks is proceed, the coverage of the cell is verified and in case of the coverage of the cell is sufficient, then the user equipment (UE) is switched to alternative network and performs random access (RA) procedure, in case of the coverage of the cell is insufficient, then the user equipment (UE) stays in the same network and upgrades to Coverage Enhancement (CE) level (k) to the level (k+1) for random access (RA) procedure.

UE switches to alternative network, only when there is a good coverage in the alternative network. If not, UE will stay with the same network and upgrade the CE level.

A very important aspect of this new approach are the low costs. Both LTE-M and NB-IoT score with low module costs as well as low operating and service prices. This is ensured by the simple chipset design, which dispenses with unnecessary LTE functions, as well as increasing production volumes.

All described solutions are LTE-based. NB-IoT and LTE-M are based on LTE and can be integrated into existing LTE infrastructures via software upgrade. Since both NB-IoT and LTE-M can be provided in the GSM and LTE spectrum, no additional spectrum licenses are required.

Unlike sensors that cannot transmit over long distances, both NB-IoT and LTE-M work via plug & play. Sensors are directly connected to the NB-IoT and/or LTE-M networks without the need to install local networks or gateways.

A further very relevant aspect of the described solutions is that they are extremely secure. NB-IoT and LTE-M are globally standardized technologies and use LTE security mechanisms according to 3GPP.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and URLLC may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

A performance of the AI/ML model or additionally Neural Network (NN) model may be based on a plurality of criteria, such as feature selection, model selection, a number of samples, etc. Feature selection may correspond to input parameters of the ML/NN model for training and testing the ML/NN model. Model selection may correspond to determining a model to be executed from a plurality of models (e.g., based a model complexity or optimization parameters). The number of samples may correspond to a number of observations for one or more features.

1. A method for gNB-UE two side model control by a user equipment device receiving an artificial intelligence and/or machine learning model status information from at least one base-station within a wireless communication network,
characterized by,
after receiving the artificial intelligence and/or machine learning model status information the user equipment decides
if the an artificial intelligence and/or machine learning model status information is activated, the user equipment maintains in the same artificial intelligence and/or machine learning model status information,
if the artificial intelligence and/or machine learning model status information is deactivated, the user equipment switches to an alternative operation mode based on assistance information from base-station.

2. The method for gNB-UE two side model control by a user equipment according to claim 1,
wherein the artificial intelligence and/or machine learning model status information comprises model status indication, model transfer information and user equipment behavior index from base-station.

3. The method for gNB-UE two side model control by a base station in a wireless communication network, wherein the method comprises:
Determination of an artificial intelligence and/or machine learning model status information
Checking the status of the artificial intelligence and/or machine learning model status information by the base-station,
if the checking results in the non-deactivation of base-station the artificial intelligence and/or machine learning model status information remains in the same the artificial intelligence and/or machine learning model status information and artificial intelligence and/or machine learning model status information is used for further proceedings,
if the check results in the deactivation of the artificial intelligence and/or machine learning model status information, the artificial intelligence and/or machine learning model status information is transmitted via the base station to at least one user equipment.

4. A method for gNB-UE two side model control by a base station in a wireless communication network, wherein the artificial intelligence and/or machine learning model status information comprises model status indication, model transfer information and user equipment behavior index from base-station.

5. A method for gNB-UE two side model control between at least a user equipment and a base station in a wireless communication network comprising an artificial and/or machine learning model training phase and an artificial and/or machine learning model inferencing phase.

6. The method according to claim 5 for gNB-UE two side model control between at least a user equipment and a base station in a wireless communication network comprising an artificial and/or machine learning model training phase and an artificial and/or machine learning model inferencing phase, wherein the artificial and/or machine learning model inferencing phase comprises the steps:
Transmitting a measurement report and/or user equipment capability for artificial and/or machine learning from a user equipment to the base-station
Transmitting a parameter configuration update for artificial and/or machine learning from the base-station to at least a user equipment
Performing artificial and/or machine learning model inferencing by the base-station and at least a user equipment
Data exchange for model transfer and/or inference output between base-station and at least one user equipment
Model performance monitoring feedback exchange between base-station and at least one user equipment.

7. A method for gNB-UE two side model control between at least a user equipment and a base station in a wireless communication network comprising an artificial and/or machine learning model inferencing phase comprising the steps:
Determination of model status change and user equipment behavior index,
Generation of a model transfer information,
Creating an artificial and/or machine learning assistance information, wherein the artificial and/or machine learning assistance information comprises model status indication, model transfer information, user equipment behaviour index,
Transmitting the artificial and/or machine learning assistance information to at least one user equipment,
Switching to the alternative operation mode based on the artificial and/or machine learning assistance information by the user equipment, and
transmitting user equipment behaviour update report from the user equipment to the base-station.

8. An apparatus for gNB-UE two side model control between a user equipment and a base-station in a wireless communication network, the apparatus comprising a wireless transceiver, a processor coupled with a memory in which computer program instructions are stored, said instructions being configured to perform operations comprising:
after receiving the artificial intelligence and/or machine learning model status information the user equipment decides
if the an artificial intelligence and/or machine learning model status information is activated, the user equipment maintains in the same artificial intelligence and/or machine learning model status information,
if the artificial intelligence and/or machine learning model status information is deactivated, the user equipment switches to an alternative operation mode based on assistance information from base-station.

9. The apparatus according to claim 8, wherein the apparatus is a User Equipment.

10. The apparatus according to claim 8, wherein the apparatus is a Base Station.

11. A wireless communication system for gNB-UE two side model control from a base station to a user equipment, wherein the base station comprises a base-station processor coupled with a base-station memory in which base-station computer program instructions are stored, said base-station computer program instructions instructions being configured such that the artificial intelligence and/or machine learning model status information comprises model status indication, model transfer information and user equipment behavior index from base-station, wherein the user equipment comprises a user-equipment processor coupled with a user-equipment memory in which user-equipment computer program instructions are stored, said user-equipment computer program instructions being configured to perform operations comprising:
after receiving the artificial intelligence and/or machine learning model status information the user equipment decides
if the an artificial intelligence and/or machine learning model status information is activated, the user equipment maintains in the same artificial intelligence and/or machine learning model status information,
if the artificial intelligence and/or machine learning model status information is deactivated, the user equipment switches to an alternative operation mode based on assistance information from base-station.
